(19) United States
(12) Patent Application Publication
(10) Pub. No.: US 2013/0271344 A1
(43) Pub. Date: Oct. 17, 2013

(54) ANTENNA DEVICE

(71) Applicant: HITACHI CABLE, LTD., Tokyo (JP)

(72) Inventors: Osamu TASAKI, Hitachi (JP); Tomoyuki Ogawa, Hitachi (JP); Shinsuke Murano, Kasama (JP)

(73) Assignee: Hitachi Cable, Ltd., Tokyo (JP)

(21) Appl. No.: 13/788,399

(22) Filed: Mar. 7, 2013

(30) Foreign Application Priority Data
Apr. 12, 2012 (JP) 2012-091071

(51) Int. Cl. H01Q 21/00

(52) U.S. Cl. CPC H01Q 21/0075
USPC 343/893

(57) ABSTRACT

An antenna device includes a substrate including a front surface, a back surface, and via holes formed therein, a plurality of patch antenna elements formed in an array on the front surface of the substrate, a feed line formed on the back surface of the substrate to feed the plurality of patch antenna elements through the via holes formed in the substrate, and a metal chassis disposed opposite the substrate with an air layer therebetween on the back surface of the substrate. The metal chassis is electrically grounded.

The present application is based on Japanese patent application No. 2012-091071 filed on Apr. 12, 2012, the entire contents of which are incorporated herein by reference.

### BACKGROUND OF THE INVENTION

1. Field of the Invention

This invention relates to an antenna device used in mobile communication base stations.

2. Description of the Related Art

The generally known antenna device used in the mobile communication base stations is one having a reflector to reflect radio waves, in which an antenna element is disposed on a front surface of the reflector, while a feed circuit to feed the antenna element is disposed on a back surface of the reflector. Refer to JP-T 2010-503356, for example.

In this conventional antenna device, a feed cable which extends from the feed circuit is passed through a hole formed in the reflector, and is soldered to the antenna element, to thereby electrically connect the antenna element and the feed circuit.

Refer to JP-T 2010-503356 and JP-A2004-120130, for example.

### SUMMARY OF THE INVENTION

However, due to the need for the hole formation in the reflector and the subsequent solder connection of the feed cable to the antenna element, the above conventional antenna device is time-consuming to produce, and costly in production.

In view of the foregoing circumstances, it is an object of the present invention to provide an antenna device, which is easy to produce, and low in cost.

According to a first feature of the present invention, an antenna device comprises;

a substrate including a front surface, a back surface, and via holes formed therein;

a plurality of patch antenna elements formed in an array on the front surface of the substrate;

a feed line formed on the back surface of the substrate to feed the plurality of patch antenna elements through the via holes; and

a metal chassis disposed opposite the substrate with an air layer therebetween on the back surface of the substrate, the metal chassis being electrically grounded.

The antenna device may further comprise a spacer disposed between the substrate and the metal chassis for holding a distance between the substrate and the metal chassis constant.

The feed line may branch a feed signal fed to a feed portion and feed each of the patch antenna elements.

The substrate may be formed in a rectangular shape, the plurality of patch antenna elements may be formed in a center region in a short side direction of the substrate and equally spaced in a long side direction of the substrate, and the feed line may extend in the long side direction of the substrate and on either sides in the short side direction of the substrate and branch to extend to a back side of each of the patch antenna elements for feeding each of the patch antenna elements through the via holes.

The feed portion may be provided substantially in a center region in the long side direction of the substrate.

A distance between the substrate and the metal chassis in the center region in the short side direction of the substrate may be greater than a distance between the substrate and the metal chassis on the either sides in the short side direction of the substrate.

The metal chassis may be bent in such a manner that a recessed portion is formed opposite the center region in the short side direction of the substrate and is recessed opposite the substrate.

The metal chassis may comprise a bottom plate and side plates as one piece, and the substrate is installed to be parallel to the bottom plate.

The metal chassis may comprise a one-side opened rectangular shape in its cross section.

A recessed portion may be provided at the bottom plate along a longitudinal direction of the metal chassis to correspond to the center region of the substrate.

### Effects of the Invention

According to the embodiment of the invention, it is possible to provide the antenna device which is easy to produce and low in cost.

### BRIEF DESCRIPTION OF THE DRAWINGS

The preferred embodiments according to the invention will be explained below referring to the drawings, wherein:

FIGS. 1A and 1B are an exploded perspective view and a cross-sectional view, respectively, showing an antenna device in one embodiment according to the invention;

FIG. 2A is a plan view showing a front surface of a substrate used in the antenna device;

FIG. 2B is a perspective view showing a back surface seen through the front surface of the substrate used in the antenna device;

FIG. 2C is a superimposed view of FIGS. 2A and 2B; and

FIG. 3 is a cross-sectional view showing an antenna device in another embodiment according to the invention.

### DETAILED DESCRIPTION OF TIM PREFERRED EMBODIMENTS

Embodiments according to the invention will be described below in conjunction with the accompanying drawings.

### The First Embodiment

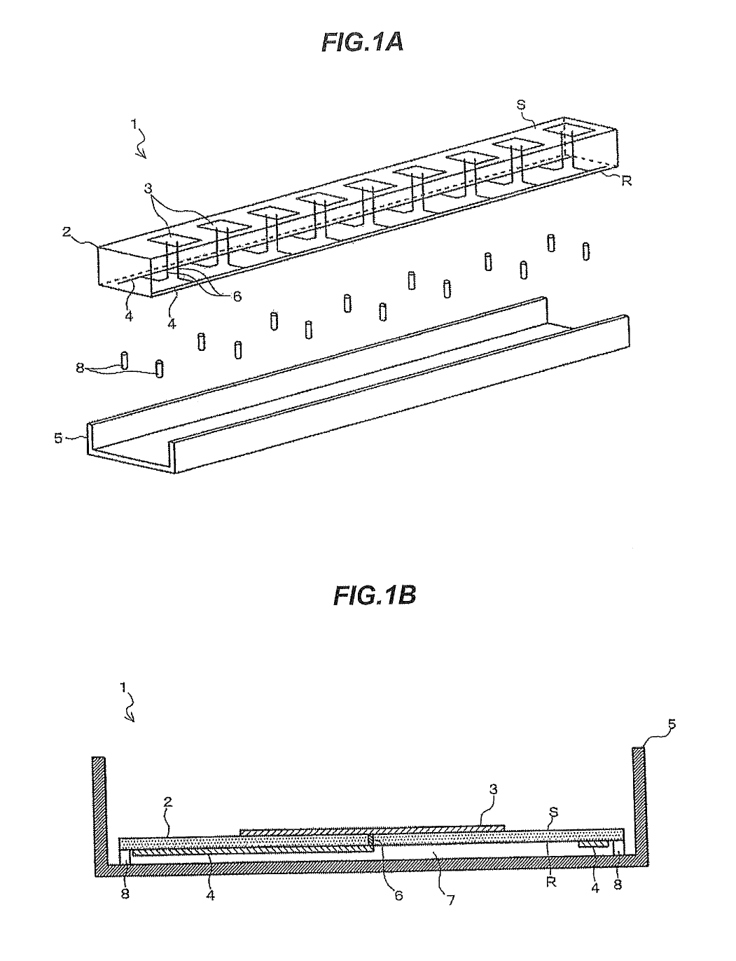

FIGS. 1A and 1B, are an exploded perspective view and a cross-sectional view, respectively, showing an antenna device in this embodiment.

As shown in FIGS. 1A and 1B, the antenna device 1 comprises a substrate 2, a plurality of patch antenna elements 3 formed in an array on a front surface S of the substrate 2, a feed line (transmission line) 4 formed on a back surface R of the substrate 2 to feed the plurality of patch antenna elements 3 through via holes (through holes) 6 formed in the substrate 2, and a metal chassis S disposed opposite the substrate 2 with an air layer 7 therebetween on the back surface R of the substrate 2 and electrically grounded.

The substrate 2 comprises a rigid substrate composed essentially of a dielectric such as an epoxy substrate or the like. In this embodiment, as the substrate 2, a 0.8 mm thick double-sided substrate formed in a rectangular shape is used. Incidentally, in FIG. 1A, for clarity of illustration, the substrate 2 is drawn thicker than it actually is.

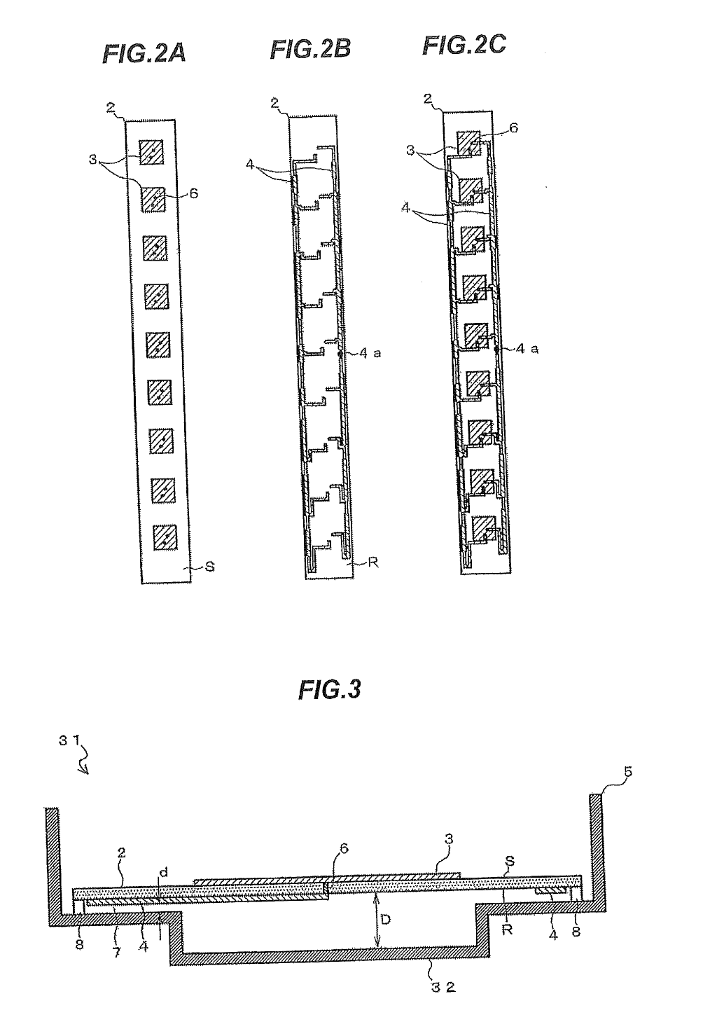

As shown in FIGS. 1A and 2A, the plurality of patch antenna elements 3 are formed in the center region in a short side direction of the substrate 2 and equally spaced in a long side direction of the substrate 2. Although in this embodiment the rectangular patch antenna elements 3 are formed, the shapes of the patch antenna elements 3 are not limited thereto. Also, although in this embodiment the nine patch antenna elements 3 are shown as being formed, the number of patch antenna elements 3 is not limited thereto.

The feed line 4 comprises microstrip lines formed on the back surface R of the substrate 2, and is configured to branch a feed signal fed to a feed portion 4a and feed each of the patch antenna elements 3. More specifically, the feed line 4 is configured to extend in the long side direction of the substrate 2 and on both sides in the short side direction of the substrate 2, branch and extend to a back side of each of the patch antenna elements 3, to feed each of the patch antenna elements 3 through the via holes 6. Incidentally, the conductor width of the feed line 4 is varied with location, in order to adjust and match impedances.

In order to efficiently feed all the patch antenna elements 3, it is preferable that the feed portion 4a to feed the feed line 4 is formed substantially in the center region in the long side direction of the substrate 2. A center conductor of the feed cable extending from a wireless communication device (not shown) is soldered and electrically connected to the feed portion 4a. An outer conductor of the feed cable is electrically connected to the metal chassis 5, and the metal chassis 5 is electrically grounded.

The metal chassis 5 is bent perpendicular to and toward the substrate 2 at edges on both sides in a width direction thereof, and is formed in one-side opened rectangular shape in cross-sectional view. In other words, the metal chassis 5 has a bottom plate and side plates as one piece, and the substrate 2 is installed to be parallel to the bottom plate. In this embodiment, as the metal chassis 5, a 1.2 mm thick aluminum chassis is used.

The metal chassis 5 functions both as a reflector to reflect radio waves radiated by the patch antenna elements 3, and as a ground conductor of the feed line 4. Generally, in a typical feed circuit, a feed line is formed on one surface of a dielectric substrate, and a ground conductor is formed on the other surface thereof, whereas the antenna device 1 in this embodiment is configured by replacing the dielectric substrate with the air layer 7 so that the feed line 4 and the metal chassis 5 (the ground conductor) are opposite each other via the air layer 7. That is, the feed line 4, the metal chassis 5, and the air layer 7 constitute the microstrip lines.

A variation in the distance between the feed line 4 and the metal chassis 5 causes a variation in the impedance, making design thereof difficult. For this reason, in this embodiment, a spacer 8 is disposed between the substrate 2 and the metal chassis 5, to keep the distance between the substrate 2 and the metal chassis 5 constant while keeping the air layer 7. Although herein the plurality of the columnar spacers 8 are shown as being disposed in two lines and substantially equally spaced in the long side direction of the substrate 2 in both the lines so as to support both side ends in the short side direction of the substrate 2, the shapes, arrangement, and the like of the spacers S are not limited thereto, but may be set arbitrarily. In this embodiment, the distance between the substrate 2 and the metal chassis S (the distance between the feed line 4 and the metal chassis 5) is set at 1 mm.

The substrate 2 and the metal chassis 5 are received in a cylindrical radome (cover) (not shown). The radome may comprise e.g. FRP (fiber-reinforced plastic). The antenna device 1 is installed in such a manner that its longitudinal direction (the long side direction of the substrate 2) is set along the vertical direction (to the ground).

Effects of this embodiment are described.

The antenna device 1 in this embodiment comprises the substrate 2, the plurality of patch antenna elements 3 arrayed on the front surface S of the substrate 2, the feed line 4 formed on the back surface R of the substrate 2 to feed the plurality of patch antenna elements 3 through the via holes 6 formed in the substrate 2, and the metal chassis 5 disposed opposite the substrate 2 with the air layer 7 therebetween on the back surface R of the substrate 2 and electrically grounded.

With this configuration, the patch antenna elements 3 and the feed line 4 are beforehand electrically connected together through the via holes 6. It is therefore possible to eliminate the time-consuming hole formation in the reflector and subsequent soldering of the feed cable extending from the feed circuit to the antenna element at the time of assembly as conventional. Accordingly, it is possible to realize the antenna device 1, which is simple in configuration, without the need for connection by human hand at the time of assembly. Thus, it is possible to shorten the assembly time, and realize the antenna device 1 which is easy to produce and low in cost.

Also, the air layer 7 has a small dielectric loss in comparison with that of the dielectric substrate. It is therefore possible to lower the loss, in comparison with when forming the feed line and the ground conductor on the front and back surfaces, respectively, of the dielectric substrate as conventional.

Further, in the antenna device 1, the spacers 8 are disposed between the substrate 2 and the metal chassis 5 to hold the distance therebetween constant, so that the distance between the feed line 4 and the metal chassis 5 is kept constant. It is therefore possible to eliminate the variation in the impedance and make the design easy.

### The Second Embodiment

The second embodiment according to the invention will be described below.

An antenna device 31 as shown in FIG. 3 is configured so that the distance D between the substrate 2 and the metal chassis 5 in the center region in the short side direction of the substrate 2, in which the plurality of patch antenna elements 3 are formed, is greater than the distance d between the substrate 2 and the metal chassis 5 on both the sides in the short side direction of the substrate 2, in which the feed line 4 is formed.

Specifically, in the antenna device 31, the metal chassis 5 is bent in such a manner that a recessed portion 32 is formed opposite the center region in the short side direction of the substrate 2, in which the plurality of patch antenna elements 3 are formed, and is recessed opposite the substrate 2. In this embodiment, d=1 mm, D=3 mm.

In general, if the antenna element and the ground conductor are too close together, the frequency width (band) radiated from the antenna element will be narrowed, thereby making the device design difficult. Since antenna element spatially radiates an electromagnetic field, if the distance between the antenna element and the ground conductor is increased, the efficiency will be enhanced and the band will be broadened. On the other hand, if the distance between the feed line 4 and the metal chassis 5 is too increased, the impedance matching will be difficult and the operation will be unstable. Accordingly, in the antenna device 31, the recessed portion 32 is formed such that only the opposite portion of the metal chassis 5 to the patch antenna elements 3 is distant from the substrate 2, to thereby enhance the antenna function.

Also, the distance d between the most part of the feed line 4 including the extending portions of the feed line 4, which extend in the longitudinal direction of the substrate 2 and the metal chassis 5, is the same as that of the antenna device 1 of FIGS. 1A and 1B. For this reason, the antenna device 31 allows lowering the loss, in comparison with the case that the feed line and the ground conductor are formed on the front and back surfaces, respectively, of the dielectric substrate.

Incidentally, although herein the metal chassis 5 is bent to form the recessed portion 32 and thereby ensure the distance between the patch antenna elements 3 and the metal chassis 5, the way to ensure the distance therebetween is not limited thereto. The recessed portion 32 is formed at the bottom plate of the metal chassis 5 along the longitudinal direction of the metal chassis 5 to correspond to the center region of the substrate 2 which mounts the patch antenna elements 3. For example, when the metal chassis 5 is formed thick, a groove may be formed in the metal chassis 5 in place of forming the recessed portion 32.

The invention is not limited to the above embodiment, but various alterations may naturally be made without departing from the spirit and scope of the invention.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An antenna device, comprising:
a substrate including a front surface, a back surface, and via holes formed therein;
a plurality of patch antenna elements formed in an array on the front surface of the substrate;
a feed line formed on the back surface of the substrate to feed the plurality of patch antenna elements through the via holes; and
a metal chassis disposed opposite the substrate with an air layer therebetween on the back surface of the substrate, the metal chassis being electrically grounded.

2. The antenna device according to claim 1, further comprising:
a spacer disposed between the substrate and the metal chassis for holding a distance between the substrate and the metal chassis constant.

3. The antenna device according to claim 1, wherein the feed line branches a feed signal fed to a feed portion and feeds each of the patch antenna elements.

4. The antenna device according to claim 3, wherein the substrate is formed in a rectangular shape, the plurality of patch antenna elements are formed in a center region in a short side direction of the substrate and equally spaced in a long side direction of the substrate, and the feed line extends in the long side direction of the substrate and on either sides in the short side direction of the substrate and branches to extend to a back side of each of the patch antenna elements for feeding each of the patch antenna elements through the via holes.

5. The antenna device according to claim 4, wherein the feed portion is provided substantially in a center region in the long side direction of the substrate.

6. The antenna device according to claim 4, wherein a distance between the substrate and the metal chassis in the center region in the short side direction of the substrate is greater than a distance between the substrate and the metal chassis on the either sides in the short side direction of the substrate.

7. The antenna device according to claim 6, wherein the metal chassis is bent in such a manner that a recessed portion is formed opposite the center region in the short side direction of the substrate and is recessed opposite the substrate.

8. The antenna device according to claim 6, wherein the metal chassis comprises a bottom plate and side plates as one piece, and the substrate is installed to be parallel to the bottom plate.

9. The antenna device according to claim 6, wherein the metal chassis comprises a one-side opened rectangular shape in its cross section.

10. The antenna device according to claim 8, wherein a recessed portion is provided at the bottom plate along a longitudinal direction of the metal chassis to correspond to the center region of the substrate.
